(19) United States
(12) Patent Application Publication
(10) Pub. No.: US 2014/0102238 A1
(43) Pub. Date: Apr. 17, 2014

(54) SHIFT LEVER OPERATION STRUCTURE

(71) Applicants: Hyundai Motor Company, Seoul (KR); Kia Motors Corp., Seoul (KR)

(72) Inventors: Jee Hyuck Choi, Seongnam-si (KR); Eun Sik Kim, Daegu (KR); Jeong Seon Min, Hwaseong-si (KR); Hee Soo Yang, Hwaseong-si (KR); Yang Rae Cho, Hwaseong-si (KR); Sug Jun Youn, Daegu (KR); Ho Sik Jang, Daegu (KR)

(73) Assignees: Kia Motors Corp., Seoul (KR); Hyundai Motor Company, Seoul (KR)

(21) Appl. No.: 14/010,182

(22) Filed: Aug. 26, 2013

(30) Foreign Application Priority Data
Oct. 15, 2012 (KR) 10-2012-0110925

(51) Int. Cl. F16H 59/08

(52) U.S. Cl. CPC F16H 59/08
USPC 74/473.36

(57) ABSTRACT

A shift lever operation structure may include a shift plate, which moves along with a shift lever so that either manual or automatic mode is selected, and has an engaging part. An engaging plate may have a connection part corresponding to the engaging part so that, during the automatic mode, the engaging plate engages with the shift plate, and during the manual mode, the engaging plate is disengaged from the shift plate. An elastic member may be assembled with the connection part of the engaging plate such that the elastic member is deformed by the insertion of the engaging part into the connection part.

### CROSS REFERENCE TO RELATED APPLICATION

The present application claims priority of Korean Patent Application Number 10-2012-0110925 filed Oct. 5, 2012, the entire contents of which application are incorporated herein for all purposes by this reference.

### BACKGROUND OF INVENTION

1. Field of Invention

The present invention relates, in general, to a shift lever operation structure capable of improving shift quality when a driver manipulates a shift lever.

2. Description of Related Art

Generally, among types of vehicle transmission there are a manual transmission, an automatic transmission, and a continuously variable transmission, and such devices operate according to changes in speed, and can convert torque and revolutions of an engine when a vehicle is driven.

The transmission can change speed when a driver manipulates a shift lever so that an automatic mode or a manual mode is selected, thereby improving driving quality and providing convenience to the driver.

However, if the shift quality of the transmission lever is poor, an action of a driver intended to change speed may not be properly transmitted to the transmission, and in this case, a commercial value of a vehicle may be degraded due to an inconvenience of changing speeds.

FIG. 1 is a perspective view of a shift lever operation structure, and FIG. 2 is a cross-sectional view taken along line a-a of the shift lever operation structure shown in FIG. 1. The shift lever operation structure includes a shift plate 10 which is moved together with a shift lever, and an engaging plate 20 which allows the operation of the shift plate to be interworked with a shift cable. During an automatic mode, the engaging plate 20 is connected with the shift plate 10 so that the driver's action to operate the shift lever is transmitted to the shift cable. When the transmission is converted to a manual mode, the engaging plate 20 is disconnected from the shift plate 10 to fix a position of the shift cable, and the operation of the shift lever is transmitted to the transmission in a form of an electric signal to carry out speed change.

As shown in FIG. 2, the shift lever operation structure, however, has problems in that connection parts 30 between the shift plate 10 and the engaging plate that are connected with each other have an accumulated tolerance, thereby causing gaps or jams to occur. That is, gaps are created at connection parts 30 between the shift plate 10 and the engaging plate 20, so when the plates are connected together, the connection becomes loose. On the contrary, if the connection parts 30 are made tight to remove the gaps, connection jams may occur at the connection parts.

Thus, there is a need to develop technologies for transmission in which gaps at connection parts 30 between the shift plate 10 and the engaging plate 20 are removed, thereby preventing excessively loose and excessively tight connections between the shift plate and the engaging plate and providing a feeling of a smooth operation of a shift lever to a driver.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made in an effort to solve at least some of the above problems occurring in the related art. Various aspects of the present invention provide a shift lever operation structure in which gaps at connection parts between a shift plate and an engaging plate are removed, thereby preventing excessively loose and excessively tight connections between the shift plate and the engaging plate and providing a feeling of a smooth operation of a shift lever to a driver.

According to various aspects of the present invention, there is provided a shift lever operation structure including: a shift plate moving along with a shift lever so that either manual or automatic mode is selected and having an irregularly-shaped engaging part; an engaging plate having an irregularly-shaped connection part corresponding to the engaging part so that, when the automatic mode is selected, the engaging plate engages with the shift plate in which the engaging part is inserted into and connected with the connection part, and when the manual mode is selected, the engaging plate is disengaged from the shift plate; and an elastic member assembled with the connection part of the engaging plate such that the elastic member is deformed by the insertion of the engaging part into the connection part, thereby removing gaps between the engaging part and connection part when the shift plate is connected with the engaging plate.

The elastic member may be a U-shaped leaf spring capable of surrounding the engaging part inserted into the connection part. The elastic member may be curved at both inner sides towards an interior space.

A width between the inner sides of the elastic member may be wider than a width of the engaging part, and a width between curved portions of the inner sides of the elastic member may be narrower than the width of the engaging part.

An end of the engaging part may be spaced apart from a corresponding portion of the connection part when the engaging part is inserted into the connection part.

Both ends of the elastic member may have hook-shaped portions, each of which is first curved in a direction towards the engaging part being inserted and then curved in a reverse direction.

The connection part of the engaging plate may have corresponding grooves at a predetermined depth on both ends for fixing the hook-shaped portions of the elastic member.

According to various aspects of the present invention, the elastic member is provided at a connection part where the engaging plate and the shift plate are connected, thereby preventing an excessively loose or an excessively tight connection therebetween.

Further, the elastic member is curved at both inner sides towards the interior space, thereby providing a feeling of definitely and comfortably operating a shift lever when the engaging part of the shift plate is inserted into the connection part of the engaging plate, and the elastic member has hook-shaped portions at its opposite ends, thereby allowing for complete fixation to the engaging plate.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a conventional shift lever operation structure;

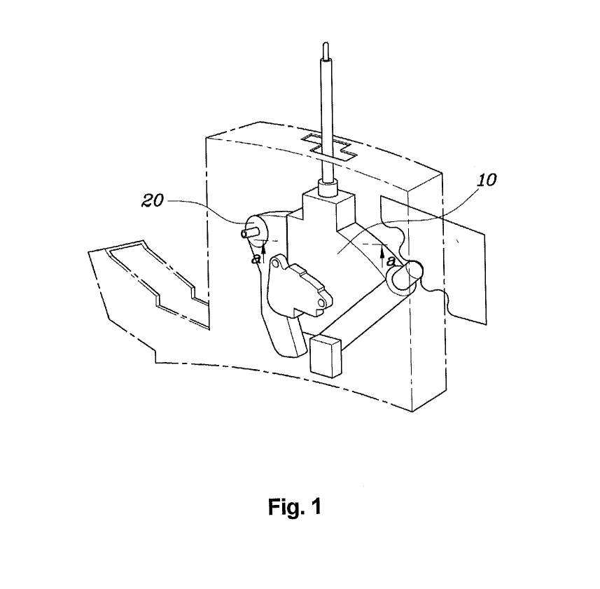

FIG. 2 is a cross-sectional view taken along line a-a of the shift lever operation structure shown in FIG. 1;

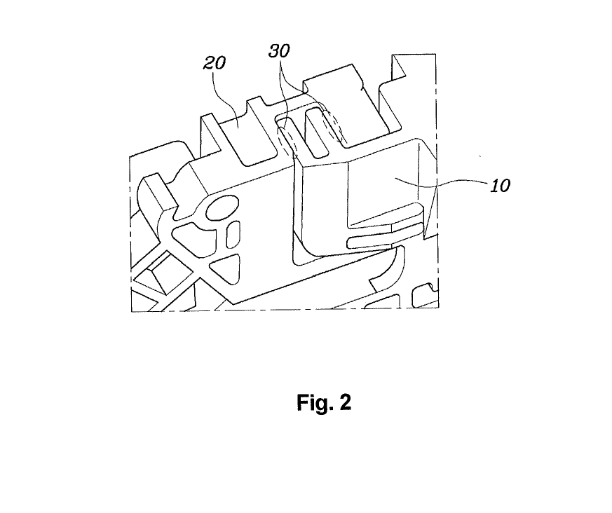

FIG. 3 is a perspective view of an exemplary shift lever operation structure according to the present invention;

FIG. 4 is a cross-sectional view taken along line A-A of the shift lever operation structure shown in FIG. 3 at a connection part where an engaging part and a connection part are connected; and

FIG. 5 is a cross-sectional view showing the connection part between the engaging part and the connection part in the shift lever operation structure shown in FIG. 3.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Wherever possible, the same reference numerals will be used throughout the drawings and the description to refer to the same or like parts.

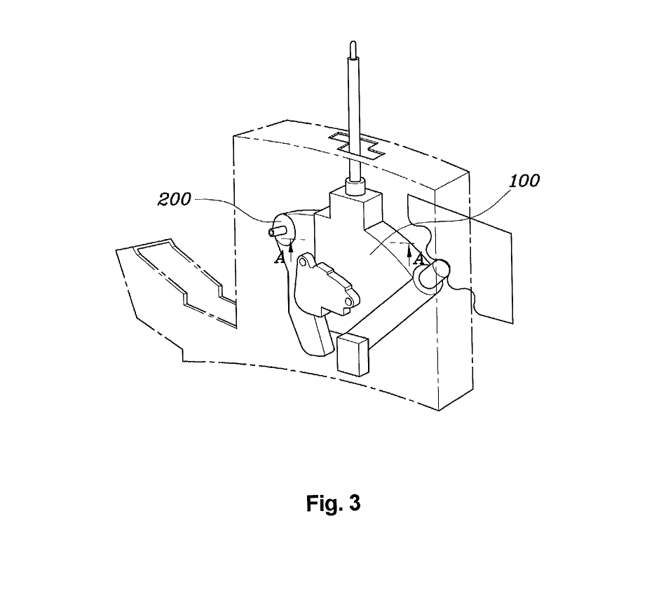

FIG. 3 is a perspective view of a shift lever operation structure according to various embodiments of the present invention. The shift lever operation structure includes: a shift plate 100 which moves along with a shift lever so that either manual or automatic mode is selected and has an irregularly-shaped engaging part 120; an engaging plate 200 which has an irregularly-shaped connection part 220 that corresponds to the engaging part 120 so that, when the automatic mode is selected, the engaging plate 200 engages with the shift plate in which the engaging part 120 is inserted into and connected with the connection part, and when the manual mode is selected, the engaging plate is disengaged from the shift plate 100; and an elastic member 300 which is assembled with the connection part 220 of the engaging plate 200 such that the elastic member is deformed by the engaging part 120 inserted into the connection part 220, thereby removing gaps between the engaging part 120 and connection part 220 when the shift plate 100 is connected with the engaging plate 200.

The engaging part 120 of the shift plate 100 and the connection part 220 of the engaging plate 200 serve to connect the shift plate 100 and the engaging plate 200. The engaging part 120 and the connection part 220 are operated such that, when the driver uses the shift lever to select the automatic mode, the engaging part 220 is inserted into the connection part 220 to allow the shift plate 100 and the engaging plate to engage with each other, and when the driver uses the shift lever to select the manual mode, the engaging part 120 is disengaged from the connection part 220.

Here, the connection part 220 of the engaging plate 200 is provided with the elastic member 300 that is elastically deformable, so that the elastic member 300 is deformed to surround the engaging part 120 by the engaging part 120 being inserted into the connection part 220, thereby removing gaps between the engaging part 120 and the connection part 220.

That is, the shift lever operation structure of the above construction is configured to remove gaps between the engaging part 120 and the connection part 220 that are connected, thereby preventing an excessively loose connection therebetween, and to prevent an excessively tight connection therebetween, thereby providing a feeling of a smooth shift operation to a driver.

Further, since the engaging part 120 is inserted into the connection part 220 while deforming the elastic member 300, when the shift lever is operated, a distinguishable feeling of shift operation is provided.

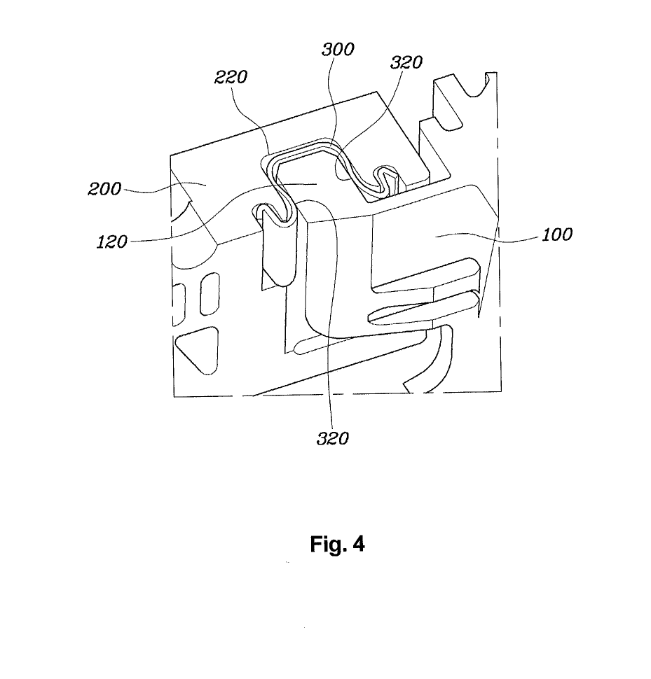

FIG. 4 is a cross-sectional view taken along line A-A of the shift lever operation structure shown in FIG. 3 at a connection part where the engaging part 120 and the connection part 220 are connected. Here, the elastic member 300 is a U-shaped leaf spring to surround the engaging part 120 inserted into the connection part 220.

The structure of the U-shaped leaf spring of the elastic member 300 is configured such that the U-shaped spring surrounds the engaging part 120 that is assembled with and inserted into the connection part 220, and at the same time, the spring is deformed by the engaging part 120. The elastic member 300 has the structure facilitating the insertion into and the assembly with the connection part 220 of the engaging plate 200, and also has a shape that is capable of removing gaps between the connection part 220 and the engaging part 120 while completely or substantially surrounding the engaging part 120 being inserted into the connection part.

Specifically, the elastic member 300 may be curved at both inner sides 320 thereof towards an interior space. Further, a width between the inner sides 320 may be wider than a width of the engaging part such that a width between curved portions of the inner sides is narrower than the width of the engaging part.

Such curved portions of the inner sides of the elastic member 300 serve to sustain a deformation by the engaging part 120 when inserted into the connection part 220.

That is, with the configuration of the elastic member 300 in which the width between both the inner sides 320 is wider than the width of the engaging part 120, and the width between the curved portions of the inner sides is narrower than the width of the engaging part 120, when inserted into the connection part, the engaging part 120 deforms the curved portions of the inner sides while pushing the curved portions outwards.

As such, when the engaging part 120 is inserted into the connection part 220, the elastic member 300 can completely or substantially remove gaps between the engaging part 120 and the connection part 220 while the engaging part comes into contact with the curved portions of the elastic member.

Moreover, since the engaging part 120 is inserted into the connection part while pushing the curved portions of the inner sides 320 outwards, a distinguishable feeling of shift operation is provided during the operation of the shift lever, and the engaging part 120 that is being inserted deforms the elastic member 300 to prevent gaps and jamming from occurring, thereby providing a definite and distinguishable feeling of shift operation to a driver.

Meanwhile, an end 140 of the engaging part 120 may be spaced from a corresponding portion 240 of the connection part 220 when the engaging part 120 is completely or substantially inserted into the connection part 220.

In order to assemble the elastic member 300 with the connection part 220, a space is required between the engaging part 120 and the connection part 220. Further, the space needs to have a further space in which the elastic member 300 is deformed when the engaging part 120 pushes the curved portions of the elastic member 300 and is inserted into the connection part 220 during the engagement between the shift plate 100 and the engaging plate 200.

That is, when completely or substantially inserted into the connection part, the end 140 of the engaging part 120 is spaced from the corresponding portion 240 of the connection part 220 to form a space in which the elastic member 300 is elastically deformed in the direction toward which the engaging part 120 is inserted into the connection part 220.

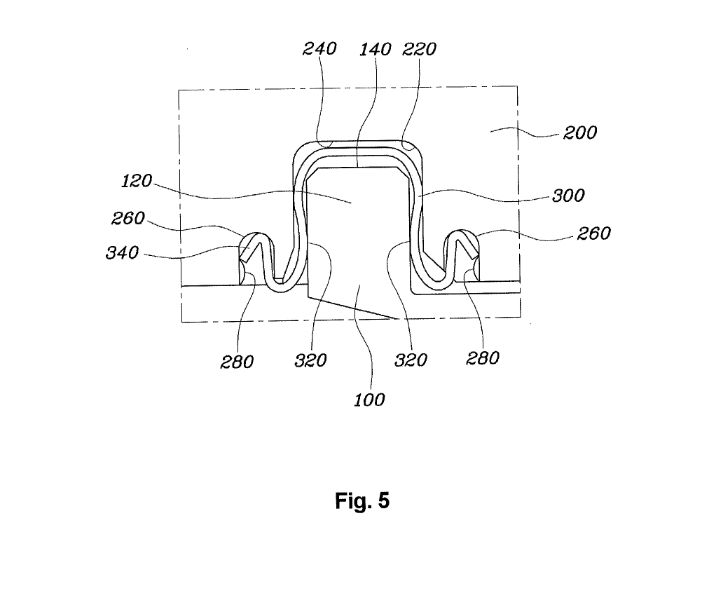

FIG. 5 is a cross-sectional view showing the connection part between the engaging part 120 and the connection part 220 in the shift lever operation structure shown in FIG. 3. Both ends of the elastic member 300 may have hook-shaped portions 340 each curved in the direction of the engaging part 120 being inserted and then curved in the reverse direction.

According to the configuration of the elastic member 300, when the engaging part 120 is decoupled from the connection part 220 by the disengagement of the shift plate 100 from the engaging plate 200 by the action of the shift lever, the elastic member 300 is prevented from being detached from the connection part 220 along with the engaging part 120.

The connection part 220 of the engaging plate 200 may have, on opposite sides thereof, grooves 260 of a certain or predetermined depth into which ends of the hook-shaped portions 349 are fixedly inserted.

Such grooves of the engaging plate 200 are provided to form a space in which the elastic member 300 is inserted into the connection part 220, and thus fixedly accommodate the ends of the hook-shaped portions 340 of the elastic member 300.

Here, a protrusion 280 may be formed around the groove 260 of the connection part 220 in order to prevent the end of the elastic member 300 inserted into the groove 260 from being detached from that groove 260.

Thus, when the elastic member 300 is assembled with the engaging plate 200, the ends of the hook-shaped portions 340 of the elastic member 300 are fixedly inserted into the grooves 260 of the connection part 220 of the engaging plate 200, thereby completely or substantially fixing the elastic member 300 to the connection part 220. Further, since the elastic member can be fixed to the connection part 220 by simple insertion into the connection part 200 without a complicated, special assembly process, manufacturing cost and production cost can be saved.

For convenience in explanation and accurate definition in the appended claims, the terms “inner” or “outer”, “wider” or “narrower”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A shift lever operation structure comprising:
a shift plate moving along with a shift lever so that either a manual or a automatic mode is selected and having an irregularly-shaped engaging part;
an engaging plate having an irregularly-shaped connection part corresponding to the engaging part so that, when the automatic mode is selected, the engaging plate engages with the shift plate in which the engaging part is inserted into and connected with the connection part, and when the manual mode is selected, the engaging plate is disengaged from the shift plate; and
an elastic member assembled with the connection part of the engaging plate such that the elastic member is deformed by the insertion of the engaging part into the connection part, thereby removing gaps between the engaging part and connection part when the shift plate is connected with the engaging plate.

2. The shift lever operation structure according to claim 1, wherein the elastic member is a U-shaped leaf spring that surrounds the engaging part when inserted into the connection part.

3. The shift lever operation structure according to claim 2, wherein the elastic member is curved at both inner sides towards an interior space.

4. The shift lever operation structure according to claim 3, wherein a width between the inner sides of the elastic member is wider than a width of the engaging part, and a width between curved portions of the inner sides of the elastic member is narrower than the width of the engaging part.

5. The shift lever operation structure according to claim 3, wherein an end of the engaging part is spaced apart from a corresponding portion of the connection part when the engaging part is inserted into the connection part.

6. The shift lever operation structure according to claim 2, wherein both ends of the elastic member have hook-shaped portions, each of which is first curved in a direction towards the engaging part being inserted and then curved in a reverse direction.

7. The shift lever operation structure according to claim 6, wherein the connection part of the engaging plate has corresponding grooves at a predetermined depth on both ends for fixing the hook-shaped portions of the elastic member.
